(19) United States
(12) Patent Application Publication
(10) Pub. No.: US 2014/0152288 A1
(43) Pub. Date: Jun. 5, 2014

(54) Reference Voltage Generator and Corresponding Integrated Circuit

(71) Applicant: iWatt Integrated Circuits Technology (Tianjin) Limited, Tianjin (CN)

(72) Inventors: Zhenyu Song, Beijing (CN); Junyue Sun, Tianjin (CN)

(73) Assignee: iWatt Integrated Circuits Technology (Tianjin) Limited, Tianjin (CN)

(21) Appl. No.: 14/097,091

(22) Filed: Dec. 4, 2013

(30) Foreign Application Priority Data
Dec. 5, 2012 (CN) 201210527535.5

(51) Int. Cl. G05F 3/18

(52) U.S. Cl. CPC G05F 3/185
USPC 323/313

(57) ABSTRACT

The present invention provides a reference voltage generator and a corresponding integrated circuit. The reference voltage generator comprises: a current mirror connected between an input voltage and ground and comprising a source current branch and a mirror current branch; a resistive element connected in series in the source current branch; and a voltage stabilizing element connected in series in the mirror current branch, wherein the mirror current generated in the mirror current branch is operable to meet working current requirements of the voltage stabilizing element, and one terminal of the voltage stabilizing element serves as a reference voltage output terminal Regarding application of an input voltage having a larger change scope, embodiments of the present invention provide a current having a smaller change scope and a lower power consumption so as to facilitate operation of high-voltage and low-power consumption integrated circuit, and particularly exhibit advantages in applications requiring a smaller current during a standby period.

### FIELD

Embodiments of the present invention generally relate to a complementary metal oxide semiconductor (CMOS) high-voltage and low-power consumption integrated circuit, and more specifically relates to a reference voltage generator and a corresponding integrated circuit for a high-voltage and low-power consumption integrated circuit.

### BACKGROUND

A reference voltage generator is a basic block to generate a coarse reference voltage in a high-voltage integrated circuit. As shown in FIG. 1, a structure of a conventional reference voltage generator is a zener in series with a current-limiting resistor (Rlim), producing a reference voltage (VZ), wherein a power supply voltage (VDDH) is input voltage.

However, in the reference voltage generator shown in FIG. 1, it is very difficult to achieve low power consumption when the input voltage increases. Furthermore, when the input voltage changes, the current in the reference voltage generator will change in a huge range, wherein the larger the range of change of the input voltage is, the larger the range of change of the current is.

According to characteristics of a zener, it can be ensured that the zener outputs a steady reference voltage only when its current is larger than its minimum break-down current. Referring to FIG. 1, the following equations can be obtained:

Imin=(VDDHmin−VZ)/Rlim; and

Imax=(VDDHmax−VZ)/Rlim

wherein Imin, as stated above, is the minimum break-down current to be satisfied in the reference voltage generator, Imax is a maximum current in the reference voltage generator, VDDHmin is a minimum input voltage of the reference voltage generator, VDDHmax is a maximum input voltage of the reference voltage generator, VZ is a reference voltage achieved by the reference voltage generator, and Rlim is resistance of a current-limiting resistor.

For example, when the input voltage changes between 7V and 18V, VZ to be achieved is 6V and Imin is 10 μA, it can be calculated from the above equations that Rlim to be used in the reference voltage generator in FIG. 1 is 100 kΩ and therefore Imax is 120 μA. As can be seen from the above, a proportion of the maximum current Imax to the minimum break-down current Imin in the reference voltage generator in FIG. 1 is 120 μA/10 μA=1200%, i.e., the maximum current Imax is 12 times the minimum break-down current Imin. The above input voltage between 7V and 18V is only exemplary. The current high voltage process can make the input voltage up to 100V so that the proportion of the maximum current Imax to the minimum break-down current Imin in the reference voltage generator might be much greater than the above 12 times, causing serious undesirable influence on normal use of the high-voltage and low-power consumption integrated circuit.

It is known from the above that the conventional reference voltage generator is disadvantageous in that the range of change of current in the reference voltage generator is too large upon large changes of the input voltage.

### SUMMARY

Exemplary embodiments of the present invention relates to a reference voltage generator for a high-voltage and low-power consumption integrated circuit.

In an embodiment of the present invention, there is provided a reference voltage generator, comprising: a current mirror connected between an input voltage and ground and comprising a source current branch and a mirror current branch; a resistive element connected in series in the source current branch; and a voltage stabilizing element connected in series in the mirror current branch, wherein the mirror current generated in the mirror current branch is operable to meet working current requirements of the voltage stabilizing element, and one terminal of the voltage stabilizing element serves as a reference voltage output terminal

In one embodiment, the current mirror comprises a first transistor connected in the source current branch and a second transistor connected in the mirror current branch.

In one embodiment, the first transistor and the second transistor both are PMOS transistors, a source of the first PMOS transistor and a source of the second PMOS transistor being connected to the input voltage, a gate of the first PMOS transistor and a gate of the second PMOS transistor being connected together, the gate and a drain of the first PMOS transistor being connected, one terminal of the resistive element being connected to the drain of the first PMOS transistor and the other terminal of the resistive element is grounded, one terminal of the voltage stabilizing element being connected to a drain of the second PMOS transistor and the other terminal of the voltage stabilizing element is grounded.

In one embodiment, a width of the second PMOS transistor is one to ten times a width of the first PMOS transistor.

In one embodiment, the resistive element comprises a resistor or an NMOS transistor.

In one embodiment, the voltage stabilizing element comprises a zener or a diode.

In one embodiment, the reference voltage generator further comprises an amplifying circuit wherein an input terminal of the amplifying circuit is connected to said one terminal of the voltage stabilizing element and an output terminal of the amplifying circuit serves as the reference voltage output terminal.

In one embodiment, the input voltage is any predetermined value in a range between 7V and 100V.

In one embodiment, there is provided an integrated circuit, comprising the above-mentioned reference voltage generator.

Embodiments of the present invention have the following advantages: embodiments of the present invention provide a reference voltage generator for a high-voltage and low-power consumption integrated circuit, and provide a current with a smaller change range and a lower power consumption for application of the input voltage with a larger change range, thereby facilitating operation of the high-voltage and low-power consumption integrated circuit. The present invention particularly exhibits advantages in applications requiring a smaller current during a standby period.

### BRIEF DESCRIPTION OF THE SEVERAL VIEWS OF THE DRAWINGS

The features, advantages and other aspects of embodiments of the present invention will be more apparent by reading through detailed description with reference to figures. In the figures, several embodiments of the present invention are illustrated in an exemplary but non-limiting manner, wherein:

FIG. 1 is a circuit diagram of a conventional reference voltage generator according to the prior art; and

FIG. 2 is a circuit diagram of a reference voltage generator for a high-voltage and low-power consumption integrated circuit according to an exemplary embodiment of the present invention.

### DETAILED DESCRIPTION

Exemplary embodiments of the present invention will be described in detail with reference to the figures. It should be noted that alternative embodiments of the structure and method disclosed herein can be readily recognized through the following depictions, and they are used as feasible embodiments which can be used without departing from the principle and spirit of the present invention.

It should be appreciated that that these embodiments are presented only to enable those skilled in the art to better understand and thereby implement the present invention but not to limit the scope of the present invention in any manner.

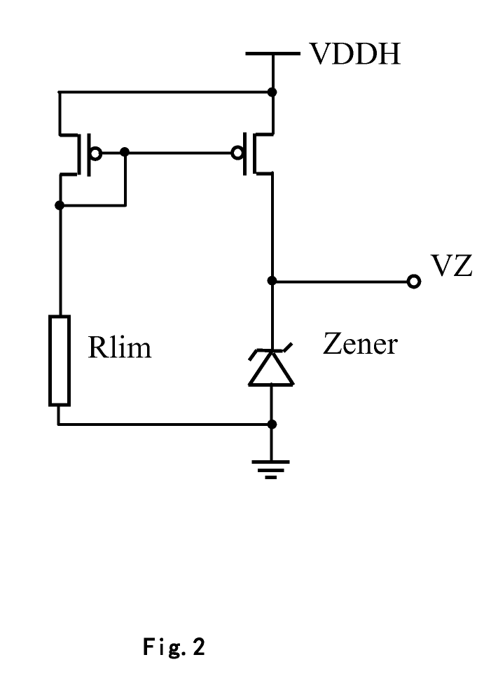

Referring to FIG. 2, it is a circuit diagram of a reference voltage generator for a high-voltage and low-power consumption integrated circuit according to an exemplary embodiment of the present invention.

As shown in FIG. 2, the reference voltage generator according to the present invention comprises a left branch and a right branch which are connected in parallel between an input voltage (VDDH) and ground, wherein the left branch comprises a P-channel complementary metal oxide semiconductor (PMOS) transistor and a current-limiting resistor (Rlim) which are connected in series, and the right branch comprises a P-channel complementary metal oxide semiconductor (PMOS) transistor and a zener which are connected in series. Gates of the PMOS transistors in the left and right branches are connected together. Sources of the PMOS transistors in the left and right branches are both connected to an input voltage, and the gate and a drain of the PMOS transistor in the left branch are connected. Since gates of the PMOS transistors in the left and right branches are connected together and sources of the PMOS transistors in the left and right branches are connected together, gate-source voltages (VGS) of the PMOS transistors are equal. As current of the PMOS transistor upon energization mainly depends on the size of the PMOS transistor and VGS, the two PMOS transistors arranged according to the above elements form a current mirror, wherein the left branch uses the PMOS transistor to generate a current, and the right branch mirrors the generated current and then fills it into the zener in the right branch. When the proportion between sizes of the left and right PMOS transistors is 1:1, a same mirror current will be generated in the right branch after the current is generated in the left branch; when the proportion between sizes of the left and right PMOS transistors is 1:N, a mirror current of N times will be generated in the right branch after the current is generated in the left branch.

In exemplary embodiments of the present invention, exemplary illustration will be presented by taking an example wherein the sizes of the left and right PMOS transistors are equal.

According to the properties of the PMOS transistor, the PMOS transistor starts to operate normally only when a voltage applied to the PMOS transistor reaches a threshold voltage (namely, a start voltage). Therefore, in the reference voltage generator shown in FIG. 2, if the threshold voltage of the PMOS transistor in the left branch is VT, the following formulas can be obtained:

Imax/Imin=(VDDHmax−VT)/(VDDHmin−VT).

wherein Imin is the minimum break-down current to be satisfied for the zener in the reference voltage generator, Imax is a maximum current in each branch of the reference voltage generator, VDDHmin is a minimum input voltage of the reference voltage generator, VDDHmax is a maximum input voltage of the reference voltage generator, and VT as mentioned above is the threshold voltage of the PMOS transistor in the left branch.

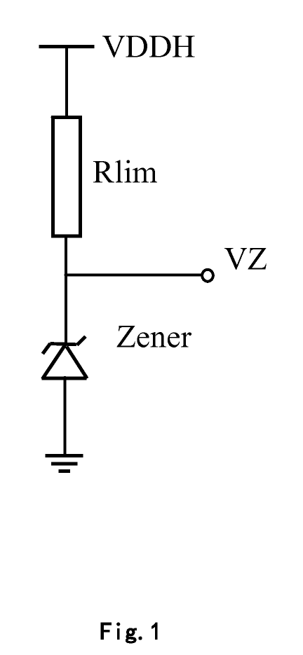

For example, when the input voltage changes between 7V and 18V, VT is 1V and Imin is 10 μA, it can be calculated from the above equations that Rlim to be used in the reference voltage generator in FIG. 1 is 600 k and therefore Imax is 28.3 μA. As can be seen from the above, a proportion of the maximum current Imax to the minimum break-down current Imin in each branch of the reference voltage generator in FIG. 1, namely, a proportion of a total maximum current to a total minimum current, is 28.3 μA/10 μA=283%, i.e., the maximum current Imax is 2.83 times the minimum break-down current Imin. As known from comparison with the description in the Background of the Invention, in case that the change range of the input voltage is consistent, the proportion of the maximum current Imax to the minimum break-down current Imin in the reference voltage generator according to exemplary embodiments of the present invention is much smaller than the proportion of the maximum current Imax to the minimum break-down current Imin in the conventional reference voltage generator, and the maximum current (28.3 μA×2=56.6 μA) in the reference voltage generator according to exemplary embodiments of the present invention is much smaller than the maximum current (120 μA) in the conventional reference voltage generator. Therefore, the reference voltage generator according to exemplary embodiments of the present invention has lower power consumption when is the input voltage has a larger change range.

As stated above, since the PMOS transistors in the current mirror in the reference voltage generator according to exemplary embodiments of the present invention may be designed to be proportional in size, the PMOS transistor in the left branch may be designed to be smaller than the PMOS transistor in the right branch so that the current in the left branch is reduced on the premise of satisfying the minimum break-down current of the zener in the right branch such that the total current and total power consumption in the whole reference voltage generator may be made smaller.

It should be noted that although the sizes of the two PMOS transistors in the current mirror in the reference voltage generator according to exemplary embodiments of the present invention may be adjusted, the proportion of the sizes of the two PMOS transistors needs to be determined according to actual situations, wherein an influence which might be exerted by design cost and electrical leakage of the reference voltage generator needs to be particularly taken into account. The reason is that if the proportion of the sizes of the two PMOS transistors is designed too large, an area occupied by one PMOS transistor will be too large so that the total cost of the integrated circuit will be increased. Meanwhile, when the proportion of the sizes of the two PMOS transistors is designed too large so that the current of one of the PMOS transistors is caused too small, the current might be submerged by electrical leakage so that the reference voltage generator will be caused not to operate normally. Preferably, the proportion of the sizes of the two PMOS transistors usually does not exceed 10 times according to evaluations of the influence that might be caused by the design cost and electrical leakage.

Various processing may be performed for the reference voltage (VZ) generated by the reference voltage generator according to the exemplary embodiments of the present invention so that it may be used for many purposes. For example, since the generated reference voltage does not have a current drive capability and is only a voltage, the current drive capability may be added thereto such that the reference voltage may be used to drive other elements and/or circuits. The reference voltage to which the current drive capability is added may be used as a power supply.

It should be appreciated that the current mirror achieved by two PMOS transistors is employed to achieve the technical effects of the present invention in the exemplary embodiments of the present invention, but the current mirror suitable for the present invention is not only limited to be achieved by two PMOS transistors and it may have a more complicated structure. That is to say, any current mirror structure which can generate the mirror current in the other branch through the current in one branch may be used for the present invention.

It should be appreciated that although the zener is used in the above embodiments to achieve the reference voltage generator according to embodiments of the present invention, the reference voltage generator may also be implemented by using other voltage stabilizing elements (devices) such as ordinary diodes because they have stability that can meet requirements of the reference voltage generator. To sum up, in various exemplary embodiments of the present invention, the voltage stabilizing elements are used to transform current of which change range might be very large to a stable voltage to generate a stable reference voltage.

However, as compared with an ordinary diode, advantages of use of the zener in the reference voltage generator lie in that the generated reference voltage is more stable so long as the current reaches the minimum break-down current (Imin) of the zener no matter how large current is applied to the zener. This is because the zener is different from the ordinary diode in respect of a slope of curve of stability. Meanwhile, the magnitudes of the references voltage generated by the reference voltage generators respectively using the zener and ordinary diode are different. For example, when the current increases by 10 times, the reference voltage generated by the reference voltage generator using the zener might change from 6V to 6.1V, whereas the reference voltage generated by the reference voltage generator using the ordinary diode might changes from 0.7V to 0.8V. Although the 0.7V reference voltage generated by the reference voltage generator using the ordinary diode might be slightly low as a reference, it may be amplified so as to achieve effects similar to the reference voltage generator using the zener.

It should be appreciated that using the current-limiting resistor Rlim in the exemplary embodiments of the present invention is only exemplary. It is feasible to use resistive elements (resistive loads) which can function similar to the resistor and transform the voltage into current in the reference voltage generator according to exemplary embodiments of the present invention, and it is unnecessary to limit them to resistors. For example, an N channel metal oxide semiconductor (NMOS) transistor may be used as the resistive element to replace the current-limiting resistor Rlim.

It should be understood from the above depictions that embodiments of the present invention may be modified and altered without departing from the true spirit of the present invention, for example, the ordinary diode can be used as a voltage stabilizing element or an NMOS transistor can be used as the resistive element; an ordinary transistor other than the MOS transistor may be used to implement the current mirror (however, the current mirror implemented by using the MOS transistor is relatively small). Depictions in the description are only illustrative and should not be regarded as restrictive.

Although the present invention has been described with reference to several embodiments, it should be understood that the present invention is not limited to the disclosed embodiments. The present invention intends to cover various modifications and equivalent arrangements included in the spirit and scope of the appended claims. The scope of the appended claims meets the broadest explanations and therefore covers all such modifications and equivalent structures and functions.

What is claimed is:

1. A reference voltage generator, comprising:
a current mirror connected between an input voltage and ground and comprising a source current branch and a mirror current branch;
a resistive element connected in series in the source current branch; and
a voltage stabilizing element connected in series in the mirror current branch, wherein the mirror current generated in the mirror current branch is operable to meet working current requirements of the voltage stabilizing element, and one terminal of the voltage stabilizing element serves as a reference voltage output terminal.

2. The reference voltage generator according to claim 1, wherein the current mirror comprises a first transistor connected in the source current branch and a second transistor connected in the mirror current branch.

3. The reference voltage generator according to claim 2, wherein the first transistor and the second transistor both are PMOS transistors, a source of the first PMOS transistor and a source of the second PMOS transistor being connected to the input voltage, a gate of the first PMOS transistor and a gate of the second PMOS transistor being connected together, the gate and a drain of the first PMOS transistor being connected, one terminal of the resistive element being connected to the drain of the first PMOS transistor and the other terminal of the resistive element is grounded, one terminal of the voltage stabilizing element being connected to a drain of the second PMOS transistor and the other terminal of the voltage stabilizing element is grounded.

4. The reference voltage generator according to claim 2 or 3, wherein a width of the second PMOS transistor is one to ten times a width of the first PMOS transistor.

5. The reference voltage generator according to any of claims 1 to 3, wherein the resistive element comprises a resistor or an NMOS transistor.

6. The reference voltage generator according to any of claims 1 to 3, wherein the voltage stabilizing element comprises a zener or a diode.

7. The reference voltage generator according to any of claims 1 to 3, further comprising an amplifying circuit wherein an input terminal of the amplifying circuit is connected to said one terminal of the voltage stabilizing element and an output terminal of the amplifying circuit serves as the reference voltage output terminal

8. The reference voltage generator according to claim 7, wherein the input voltage is any predetermined value in a range between 7V and 100V.

9. An integrated circuit, comprising the reference voltage generator according to any of claims 1-8.
